(19) United States
(12) Patent Application Publication
(10) Pub. No.: US 2024/0113531 A1
(43) Pub. Date: Apr. 4, 2024

(54) POWER STORAGE SYSTEM

(71) Applicant: HONDA MOTOR CO., LTD., Tokyo (JP)

(72) Inventors: Yasuo YAMADA, Saitama (JP); Yasushi OGIHARA, Saitama (JP); Yoshio KOJIMA, Saitama (JP)

(73) Assignee: HONDA MOTOR CO., LTD., Tokyo (JP)

(21) Appl. No.: 18/373,627

(22) Filed: Sep. 27, 2023

(30) Foreign Application Priority Data
Sep. 30, 2022 (JP) 2022-157934
Dec. 21, 2022 (JP) 2022-204441

(51) Int. Cl. H02J 7/00; B60L 58/19; H02M 3/335; H02P 27/06

(52) U.S. Cl. CPC H02J 7/0024; B60L 58/19; H02M 3/33584; H02P 27/06; H01M 10/44

(57) ABSTRACT

A power storage system includes a first battery, a three-phase motor, an inverter, a DC power supply circuit, a branch circuit, a capacitor, a pre-charge circuit located on the electric power transmission path between the inverter and the first battery and connected between the inverter and the connection portion of the DC power supply circuit, a converter connected to the pre-charge circuit, and a second battery connected to the converter and having a voltage lower than the first voltage and the second voltage.

### CROSS-REFERENCE RELATED APPLICATIONS

This application is based on and claims priority under 35 USC 119 from Japanese Patent Application No. 2022-157934 filed on Sep. 30, 2022, and Japanese Patent Application No. 2022-204441 filed on Dec. 21, 2022.

### TECHNICAL FIELD

The present disclosure relates to a power storage system.

### BACKGROUND ART

In recent years, researches and developments have been conducted on charging and power supply in a vehicle including a secondary battery which contributes to energy efficiency in order to allow more people to have access to affordable, reliable, sustainable and advanced energy.

In relation to charging and power supply in a vehicle including a secondary battery, there are two types of charging equipment such as charge stations which are compatible with 400 V class and 800 V class, respectively. When a vehicle is compatible with only the 400 V class charging equipment, the vehicle cannot enjoy quick charging performance of the 800 V class charging equipment by the 800 V class charging equipment.

In a case where the vehicle is both compatible with the 400 V class charging equipment and the 800 V class charging equipment, generally, a voltage is boosted to 800 V by a voltage converter when charging by the 400 V class charging equipment, or the voltage is stepped down to 400 V by the voltage converter when charging by the 800 V class charging equipment. However, using such voltage converter for charging deteriorates efficiency during charging.

In this regard, there is known a vehicle which switches a connection system of a battery module so as to be chargeable by both 400 V class charging equipment and 800 V class charging equipment without using any voltage converter for charging (for example, see JP2019-080474A and JP2020-150618A).

In the meantime, there are two types of auxiliary machines used in a vehicle, one is driven at 400 V class and the other one is driven at 800 V class. In the vehicle in which the connection system of the battery module is switched, voltage conversion is generally performed by a voltage converter for an auxiliary machine, for example, when a 400 V class auxiliary machine is driven during charging by the 800 V class charging equipment, or when an 800 V class auxiliary machine is driven during charging by the 400 V class charging equipment. However, such voltage converter for an auxiliary machine is expensive and thus a manufacturing cost increases.

### SUMMARY

An aspect of the present disclosure provides a power storage system which can be efficiently charged according to a voltage state of charging equipment and can reduce a manufacturing cost.

According to an aspect of the present disclosure, there is provided a power storage system including: a first battery including a first power storage unit, a second power storage unit, and a first switch unit, the first switch unit being configured to switch between a first voltage state in which the first power storage unit and the second power storage unit are connected in series and chargeable at a first voltage, and a second voltage state in which the first power storage unit and the second power storage unit are connected in parallel and chargeable at a second voltage; a three-phase motor including coils of three phases connected at a neutral point, the three-phase motor being configured to be driven by electric power supplied from the first battery; an inverter connected on an electric power transmission path between the first battery and the three-phase motor; a DC power supply circuit connected to a connection portion located on an electric power transmission path between the inverter and the first battery; a branch circuit branched from the DC power supply circuit on a positive electrode side and connected to the neutral point; a capacitor including one end and an other end, the one end being connected to a negative-electrode-side electric power supply circuit which connects the inverter and the first battery, and the other end being connected to the branch circuit or a positive-electrode-side electric power supply circuit which connects the inverter and the first battery; a pre-charge circuit located on the electric power transmission path between the inverter and the first battery and connected between the inverter and the connection portion of the DC power supply circuit; a converter connected to the pre-charge circuit; and a second battery connected to the converter and having a voltage lower than the first voltage and the second voltage.

According to the above embodiment, the power storage system can be efficiently charged according to a voltage state of charging equipment and can reduce a manufacturing cost.

### BRIEF DESCRIPTION OF DRAWINGS

FIG. 1 illustrates a configuration of a power storage system 1 according to a first embodiment.

FIG. 2 illustrates a first voltage state (800 V startup) of a first battery 2.

FIG. 3 illustrates a second voltage state (400 V startup) of the first battery 2.

FIG. 4 illustrates a flow of a current during traveling of an electric vehicle including the power storage system 1 according to the first embodiment.

FIG. 5 illustrates a flow of a current when the electric vehicle including the power storage system 1 according to the first embodiment is charged at a first voltage (800 V).

FIG. 6 illustrates a flow of a current when the electric vehicle including the power storage system 1 according to the first embodiment is charged at a second voltage (400 V).

FIG. 7 illustrates an operation sequence during traveling of the electric vehicle including the power storage system 1 according to the first embodiment.

FIG. 8 illustrates an operation sequence when the electric vehicle including the power storage system 1 according to the first embodiment is charged at the first voltage (800 V).

FIG. 9 illustrates an operation sequence when the electric vehicle including the power storage system 1 according to the first embodiment is charged at the second voltage (400 V).

FIG. 10 illustrates a configuration of an electric vehicle including a power storage system 1 according to a second embodiment.

FIG. 11 illustrates a flow of a current during traveling of the electric vehicle including the power storage system 1 according to the second embodiment.

FIG. 12 illustrates a flow of a current when the electric vehicle including the power storage system 1 according to the second embodiment is charged at a first voltage (800 V).

FIG. 13 illustrates a flow of a current when the electric vehicle including the power storage system 1 according to the second embodiment is charged at a second voltage (400 V).

FIG. 14 illustrates an operation sequence during traveling of the electric vehicle including the power storage system 1 according to the second embodiment.

FIG. 15 illustrates an operation sequence when the electric vehicle including the power storage system 1 according to the second embodiment is charged at the first voltage (800 V).

FIG. 16 illustrates an operation sequence when the electric vehicle including the power storage system 1 according to the second embodiment is charged at the second voltage (400 V).

### DESCRIPTION OF EMBODIMENTS

Hereinafter, a power storage system according to embodiments of the present disclosure will be described with reference to the drawings.

### First Embodiment

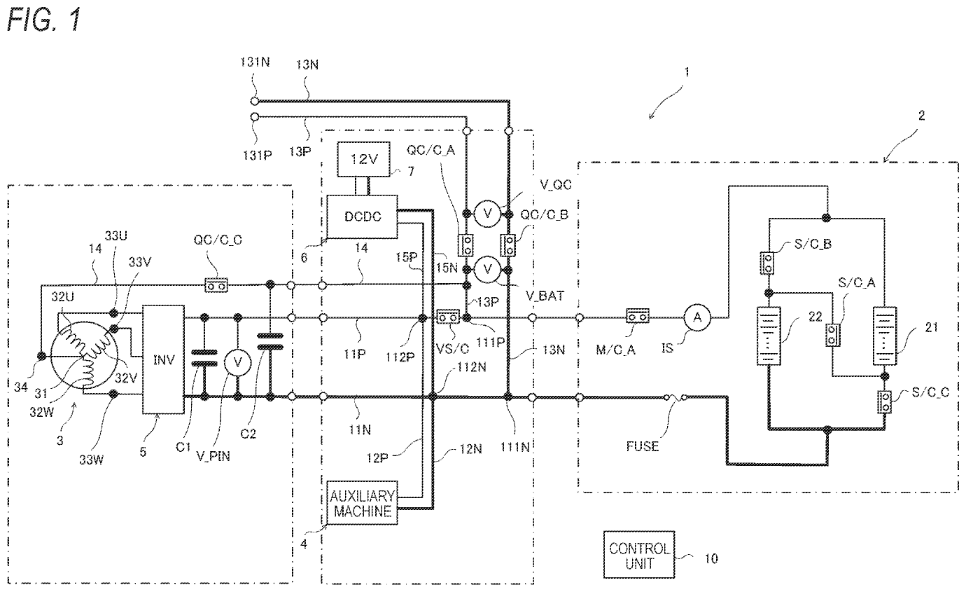

A power storage system 1 according to a first embodiment illustrated in FIG. 1 is mounted on an electric vehicle such as an electric automobile. The electric vehicle including the power storage system 1 is compatible with charging equipment of 400 V class and 800 V class. The electric vehicle can not only quickly charge a first battery 2 at charge voltages of 400 V and 800 V but also efficiently drive a three-phase motor 3 and an auxiliary machine 4 at a base voltage of 800 V.

Specifically, as illustrated in FIG. 1, the power storage system 1 includes the first battery 2, the three-phase motor 3, the auxiliary machine 4, an inverter 5 (PDU), a DC-DC converter 6, a second battery 7, a first smoothing capacitor C1, a second smoothing capacitor C2, converter circuits 15P and 15N, electric power supply circuits 11P and 11N, auxiliary machine drive circuits 12P and 12N. DC power supply circuits 13P and 13N, a branch circuit 14, and a control unit 10.

As illustrated in FIGS. 1 to 3, the first battery 2 includes a first power storage unit 21, a second power storage unit 22, first to fourth contactors M/C_A, S/C_A, S/C_B, S/C_C, a current sensor IS, and a current breaker FUSE.

The first power storage unit 21 and the second power storage unit 22 are battery modules which can perform charging and discharging of 400 V.

The first contactor M/C_A is provided on a positive electrode side end of the first battery 2 and functions as a main switch which turns on and off connection to the outside (electric power supply circuit 11P) of the first battery 2.

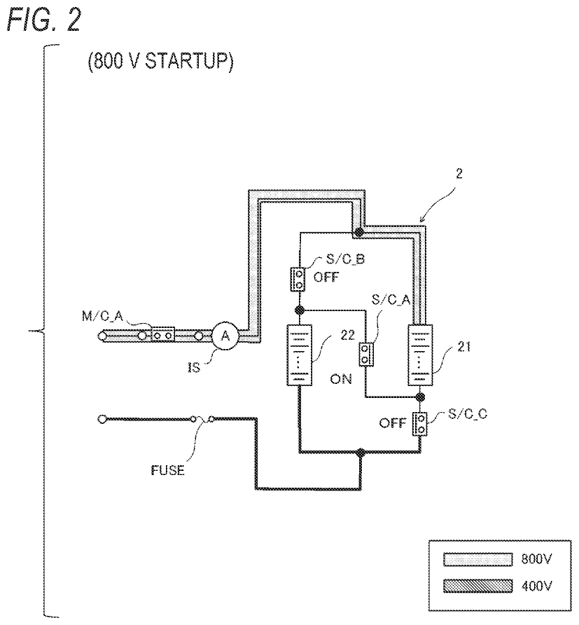

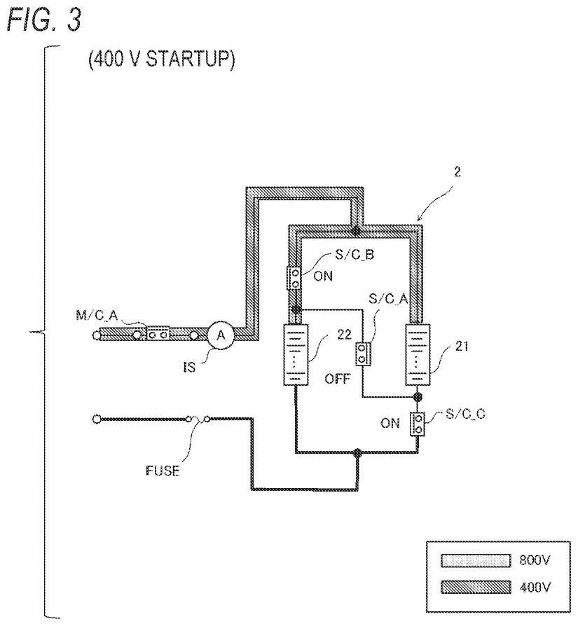

The second to fourth contactors S/C_A, S/C_B, and S/C_C switch a connection state between the first power storage unit 21 and the second power storage unit 22. For example, as illustrated in FIG. 2, when the second contactor S/C_A is turned on whereas the third contactor S/C_B and the fourth contactor S/C_C are turned off, the first battery 2 is in a first voltage state (800 V startup) in which the first power storage unit 21 and the second power storage unit 22 are connected in series, so that the first battery 2 can perform charging and discharging at 800 V. In addition, as illustrated in FIG. 3, when the second contactor S/C_A is turned off whereas the third contactor S/C_B and the fourth contactor S/C_C are turned on, the first battery 2 is in a second voltage state (400 V startup) in which the first power storage unit 21 and the second power storage unit 22 are connected in parallel, so that the first battery 2 can perform charging and discharging at 400 V. The term startup refers to a concept including driving during traveling of the electric vehicle having the power storage system 1 and charging during stopping of the electric vehicle. The second to fourth contactors S/C_A, S/C_B, and S/C_C are an example of a first switch unit configured to switch between the first voltage state (800 V startup) and the second voltage state (400 V startup).

The current sensor IS is provided between the first contactor M/C_A and the power storage units 21 and 22 to measure a current.

The current breaker FUSE is provided on a negative electrode side end of the first battery 2 and cuts off the connection to the outside (electric power supply circuit 11N) of the first battery 2 when an abnormality occurs. In the power storage system 1 according to the present embodiment, the current breaker FUSE is implemented by a pyro-fuse which can intentionally cut off a current according to an electric signal. When an abnormality occurs (for example, vehicle collision or short-circuit in the first battery 2), the current breaker FUSE performs a cut-off operation, and all the contactors in the first battery 2 are turned off (opened).

Accordingly, when an abnormality occurs, the connection to the outside can be cut off on both the positive and negative end sides of the first battery 2. Additionally, in both the first voltage state (800 V startup) and the second voltage state (400 V startup), reliable circuit cut-off can be performed by turning off the plurality of contactors on the circuit even when contactor welding occurs. Further, since a pyro-fuse is used as the current breaker FUSE, it is not necessary to provide a contactor on the negative electrode side end of the first battery 2, and thus the number of components and a cost can be reduced.

The three-phase motor 3 includes three-phase coils 32U, 32V, and 32W, one end side of each of which is connected to a neutral point 31. The three-phase motor 3 is rotationally driven by electric power supplied from the first battery 2 via the inverter 5. The three-phase motor 3 in the present embodiment includes a U-phase terminal 33U, a V-phase terminal 33V, and a W-phase terminal 33W, each of which is connected to the other end side of each of the coils 32U, 32V, and 32W, respectively, and a neutral point terminal 34 connected to the neutral point 31. The U-phase terminal 33U, the V-phase terminal 33V, and the W-phase terminal 33W are connected to the inverter 5, and the neutral point terminal 34 is connected to the branch circuit 14.

The inverter 5 converts DC electric power supplied from the first battery 2 into three-phase AC electric power by switching a plurality of switching elements and rotationally drives the three-phase motor 3. When a DC (400 V) is supplied from the branch circuit 14 to the neutral point 31 of the three-phase motor 3, the inverter 5 can function as a booster circuit by switching the plurality of switching elements to boost the DC (to 800 V) using the coils 32U, 32V, and 32W. That is, the coils 32U, 32V, and 32W wound around a stator core are used as transformers. The inverter 5 allows a current to flow from the three-phase motor 3 to the first battery side regardless of on and off of a gate, and allows a current to flow from the first battery side to the three-phase motor 3 only when the gate is on.

The auxiliary machine 4 is a high-voltage driven in-vehicle device which can be driven by DC electric power from the first battery 2 and an external power supply. For example, the auxiliary machine 4 includes an electric compressor or a heater for air-conditioning. The auxiliary machine 4 is connected to the first battery 2 via the auxiliary machine drive circuits 12P and 12N, a seventh contactor VS/C, and the electric power supply circuits 11P and 11N, which will be described later. The seventh contactor VS/C is an example of a third switch unit. The auxiliary machine 4 in the present embodiment is operated at the base voltage of 800 V.

The DC-DC converter 6 is a bidirectional DC-DC converter which can step down electric power input from one side and can boost electric power input from the other side. The DC-DC converter 6 includes one side connected with the electric power supply circuits 11P and 11N via the converter circuits 15P and 15N and the other side connected with the second battery 7 having a voltage (12 V) lower than that of the first battery 2. The DC-DC converter 6 steps down DC electric power from the first battery 2 or the external power supply to charge the second battery 7. The DC-DC converter 6 boosts DC electric power from the second battery 7 to a first voltage (800 V) to pre-charge the first smoothing capacitor C1 and the second smoothing capacitor C2 when the electric vehicle starts traveling or 800 V charging is started. The DC-DC converter 6 boosts the DC electric power from the second battery 7 to a second voltage (400 V) to pre-charge the first smoothing capacitor C1 and the second smoothing capacitor C2 when 400 V charging is started. The DC-DC converter 6 is provided with an ammeter (not illustrated). The second battery 7 is connected with a low-voltage driven in-vehicle device (not illustrated).

The electric power supply circuits 11P and 11N are configured as a positive and negative pair and connect the first battery 2 and the inverter 5 (three-phase motor 3). The electric power supply circuits 11P and 11N are provided with connection portions 111P and 111N connected to the DC power supply circuits 13P and 13N and are provided with connection portions 112P and 112N connected to the auxiliary machine drive circuits 12P and 12N (auxiliary machine 4) and the converter circuits 15P and 15N (DC-DC converter 6) on a side closer to the inverter 5 than the connection portions 111P and 111N. The electric power supply circuit 11P on the positive electrode side is provided with the seventh contactor VS/C which turns on and off the circuit between the connection portion 112P connected to the auxiliary machine drive circuit 12P and the converter circuit 15P, and the connection portion 11P connected to the DC power supply circuit 13P. A first voltage sensor V_PIN is provided on the electric power supply circuits 11P and 11N on a side of the inverter 5 and between the electric power supply circuit 11P on the positive electrode side and the electric power supply circuit 11N on the negative electrode side.

The first smoothing capacitor C1 is provided on the electric power supply circuits 11P and 11N on a side of the inverter 5 and between the electric power supply circuit 11P on the positive electrode side and the electric power supply circuit 11N on the negative electrode side. The second smoothing capacitor C2 is provided between the electric power supply circuit 11N on the negative electrode side and the branch circuit 14.

The DC power supply circuits 13P and 13N are configured as a positive and negative pair and include one end provided with charge terminals 131P and 131N to which an external power supply such as charging equipment can be connected and the other end connected to the electric power supply circuits 11P and 11N via the connection portions 111P and 111N. The DC power supply circuits 13P and 13N are provided with an eighth contactor QC/C_A and a ninth contactor QC/C_B for turning on and off the respective circuits, a second voltage sensor V_BAT at a position closer to the connection portions 111P and 111N than the eighth contactor QC/C_A and the ninth contactor QC/C_B, and a third voltage sensor V_QC at a position closer to the charge terminals 131P and 131N than the eighth contactor QC/C_A and the ninth contactor QC/C_B.

The branch circuit 14 is branched, in the DC power supply circuit 13P on the positive electrode side, at a position closer to the connection portion 111P than the eighth contactor Q/C_A and the second voltage sensor V_BAT and is connected to the neutral point 31 (neutral point terminal 34) of the three-phase motor 3. An intermediate portion of the branch circuit 14 is provided with a tenth contactor QC/C_C for turning on and off the circuit. The tenth contactor QC/C_C is an example of a second switch unit.

The control unit 10 is, for example, a vehicle ECU and controls driving and charging of the power storage system 1. Specifically, the control unit 10 performs on and off control of the first to fourth contactors M/C_A, S/C_A, S/C_B, and S/C_C, the seventh to tenth contactors VS/C, QC/C_A, QC/C_B, and QC/C_C, detection of welding of these contactors, and control of the DC-DC converter 6 and the inverter 5.

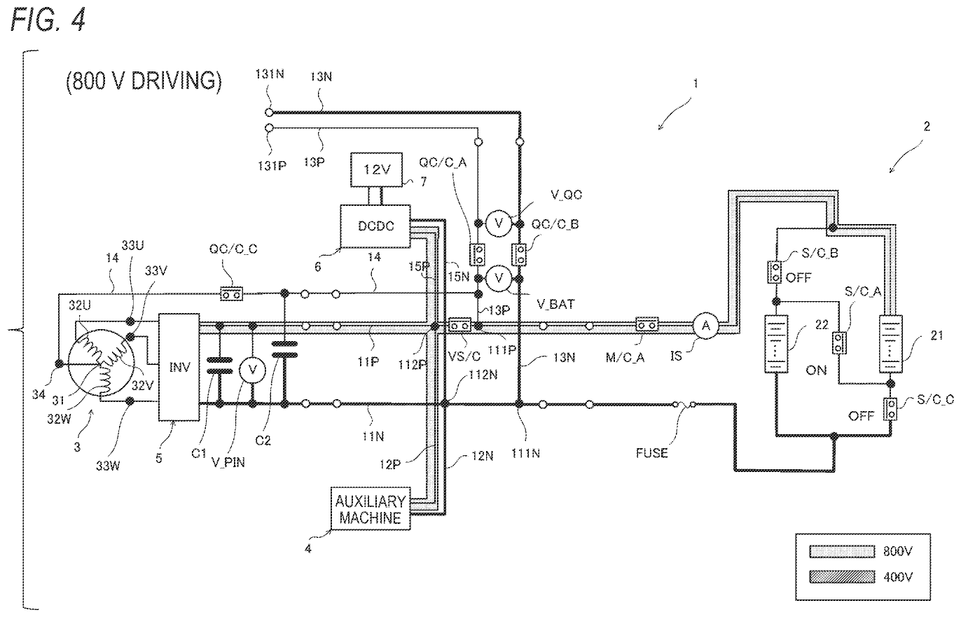

Next, an operation of the power storage system 1 will be described with reference to FIGS. 4 to 9.

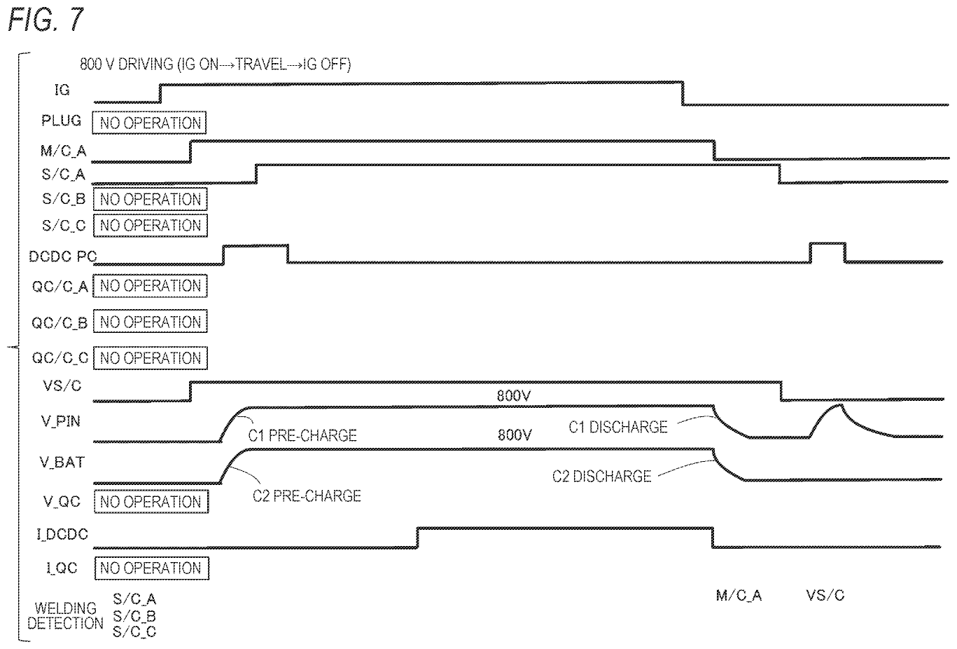

FIG. 4 illustrates a flow of a current during traveling (800 V driving) of the electric vehicle including the power storage system 1 according to the first embodiment, and FIG. 7 illustrates an operation sequence during the traveling (800 V driving) of the electric vehicle including the power storage system 1 according to the first embodiment.

When an ignition switch IG of the electric vehicle is turned on, the control unit 10 first turns on the first contactor M/C_A and the seventh contactor VS/C and checks detected voltage values of the first voltage sensor V_PIN and the second voltage sensor V_BAT. When the detected voltage values of the first voltage sensor V_PIN and the second voltage sensor V_BAT increase, the control unit 10 determines that any one of the second to fourth contactors S/C_A, S/C_B, and S/C_C is welded and performs abnormality notification.

When the control unit 10 determines that the second to fourth contactors S/C_A, S/C_B, and S/C_C are not welded, the control unit 10 boosts electric power of the second battery 7 to the first voltage (800 V) by a boost operation of the DC-DC converter 6 and pre-charges the first smoothing capacitor C1 and the second smoothing capacitor C2. When pre-charging of the first smoothing capacitor C1 and the second smoothing capacitor C2 is completed, the control unit 10 turns on the second contactor S/C_A, connects the circuit in the first battery 2 to the first voltage state (800 V startup), and then stops the boost operation of the DC-DC converter 6. Accordingly, travel of the electric vehicle is enabled. At this time, the auxiliary machine 4 is connected to the electric power supply circuits 11P and 11N via the auxiliary machine drive circuits 12P and 12N and is driven by the first voltage (800 V) supplied from the battery 2.

On the other hand, when the ignition switch IG is turned off the control unit 10 first turns off the first contactor M/C_A and checks the detected voltage values of the first voltage sensor V_PIN and the second voltage sensor V_BAT. When the detected voltage values of the first voltage sensor V_PIN and the second voltage sensor V_BAT do not decrease due to discharging of the first and second smoothing capacitors C1 and C2, the control unit 10 determines that the first contactor M/C_A is welded, and performs abnormality notification.

When the control unit 10 determines that the first contactor M/C_A is not welded, the control unit 10 turns off the second contactor S/C_A and the seventh contactor VS/C after discharging of the first and second smoothing capacitors C1 and C2 is completed. Thereafter, the control unit 10 further boosts the electric power of the second battery 7 to the first voltage (800 V) by the boost operation of the DC-DC converter 6, charges the first smoothing capacitor C1 again and checks the detected voltage value of the second voltage sensor V_BAT. When the detected voltage value of the second voltage sensor V_BAT increases, the control unit 10 determines that the seventh contactor VS/C is welded and performs abnormality notification.

When the control unit 10 determines that the seventh contactor VS/C is not welded, the control unit 10 stops the boost operation of the DC-DC converter 6 and ends the operation sequence during traveling.

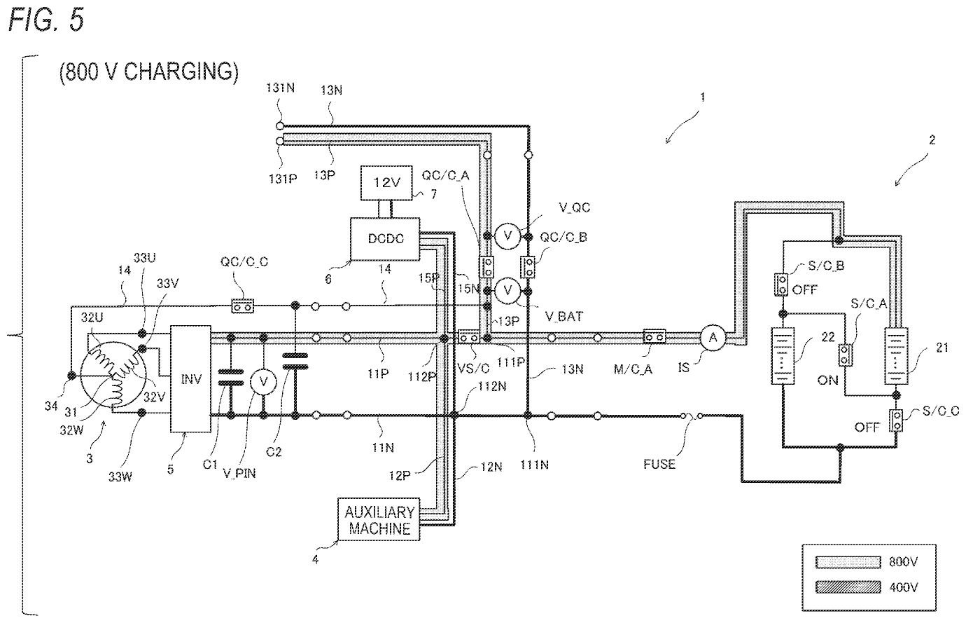

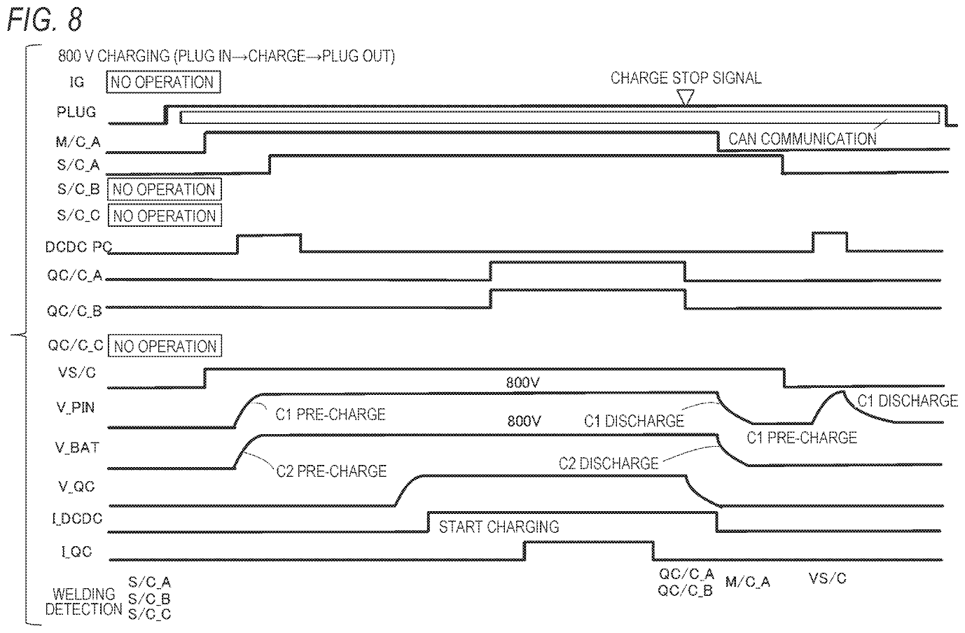

FIG. 5 illustrates a flow of a current during first-voltage charging (800 V charging) of the electric vehicle including the power storage system 1 according to the first embodiment, and FIG. 8 illustrates an operation sequence during the first-voltage charging (800 V charging) of the electric vehicle including the power storage system 1 according to the first embodiment.

When a charge plug is connected to the charge terminals 131P and 131N, the control unit 10 performs CAN communication with charging equipment to recognize a charge voltage. When the charge voltage is the first voltage (800 V), the control unit 10 first turns on the first contactor M/C_A and the seventh contactor VS/C and checks the detected voltage values of the first voltage sensor V_PIN and the second voltage sensor V_BAT. When the detected voltage values of the first voltage sensor V_PIN and the second voltage sensor V_BAT increase, the control unit 10 determines that any one of the second to fourth contactors S/C_A, S/C_B, and S/C_C is welded and performs abnormality notification.

When the control unit 10 determines that the second to fourth contactors S/C_A, S/C_B, and S/C_C are not welded, the control unit 10 boosts electric power of the second battery 7 to the first voltage (800 V) by a boost operation of the DC-DC converter 6 and pre-charges the first smoothing capacitor C1 and the second smoothing capacitor C2. When pre-charging of the first smoothing capacitor C1 and the second smoothing capacitor C2 is completed, the control unit 10 turns on the second contactor S/C_A, connects the circuit in the first battery 2 to the first voltage state (800 V), and then stops the boost operation of the DC-DC converter 6. Accordingly, the first battery 2 is in a state in which charging with the first voltage (800 V) can be started.

Thereafter, the control unit 10 turns on the eighth contactor QC/C_A and the ninth contactor QC/C_B to start charging the first battery 2 with the first voltage (800 V). At this time, the auxiliary machine 4 is connected to the DC power supply circuits 13P and 13N via the auxiliary machine drive circuits 12P and 12N and the seventh contactor VS/C and is driven by the first voltage (800 V) supplied from the charging equipment.

On the other hand, when the control unit 10 determines that a charge stop signal is received, the control unit 10 turns off the eighth contactor QC/C_A and the ninth contactor QC/C_B and checks a detected voltage value of the third voltage sensor V_QC. When the detected voltage value of the third voltage sensor V_QC does not decrease, the control unit 10 determines that the eighth contactor QC/C_A and the ninth contactor QC/C_B are welded and performs abnormality notification.

When the control unit 10 determines that the eighth contactor QC/C_A and the ninth contactor QC/C_B are not welded, the control unit 10 turns off the first contactor M/C_A and checks the detected voltage values of the first voltage sensor V_PIN and the second voltage sensor V_BAT. When the detected voltage values of the first voltage sensor V_PIN and the second voltage sensor V_BAT do not decrease due to discharging of the first and second smoothing capacitors C1 and C2, the control unit 10 determines that the first contactor M/C_A is welded, and performs abnormality notification.

When the control unit 10 determines that the first contactor M/C_A is not welded, the control unit 10 turns off the second contactor S/C_A and the seventh contactor VS/C after discharging of the first and second smoothing capacitors C1 and C2 is completed. Thereafter, the control unit 10 further boosts the electric power of the second battery 7 to the first voltage (800 V) by the boost operation of the DC-DC converter 6, charges the first smoothing capacitor C1 again and checks the detected voltage value of the second voltage sensor V_BAT. When the detected voltage value of the second voltage sensor V_BAT increases, the control unit 10 determines that the seventh contactor VS/C is welded and performs abnormality notification.

When the control unit 10 determines that the seventh contactor VS/C is not welded, the control unit 10 stops the boost operation of the DC-DC converter 6 and ends the operation sequence during first-voltage (800 V) charging.

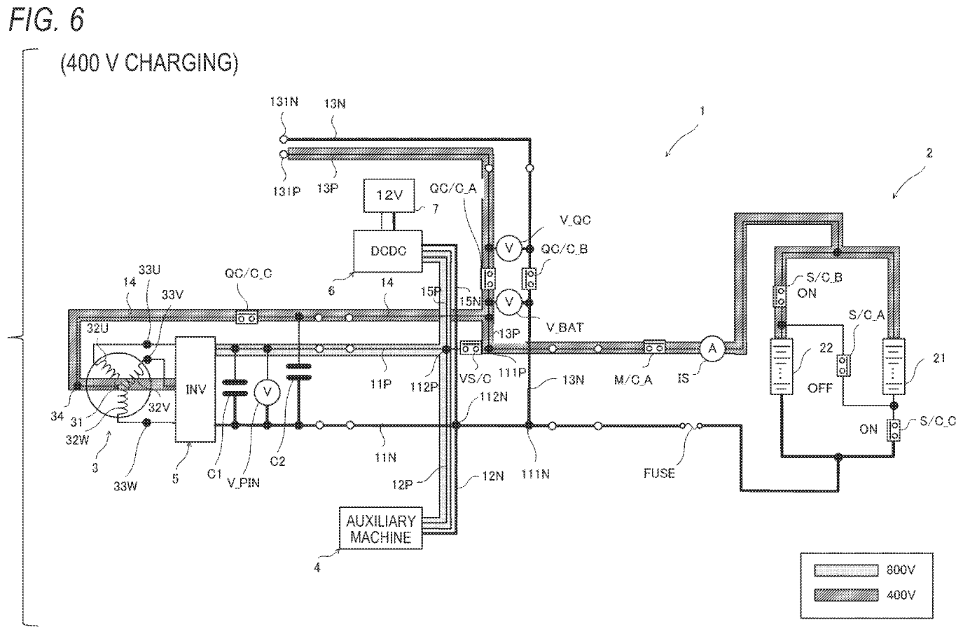

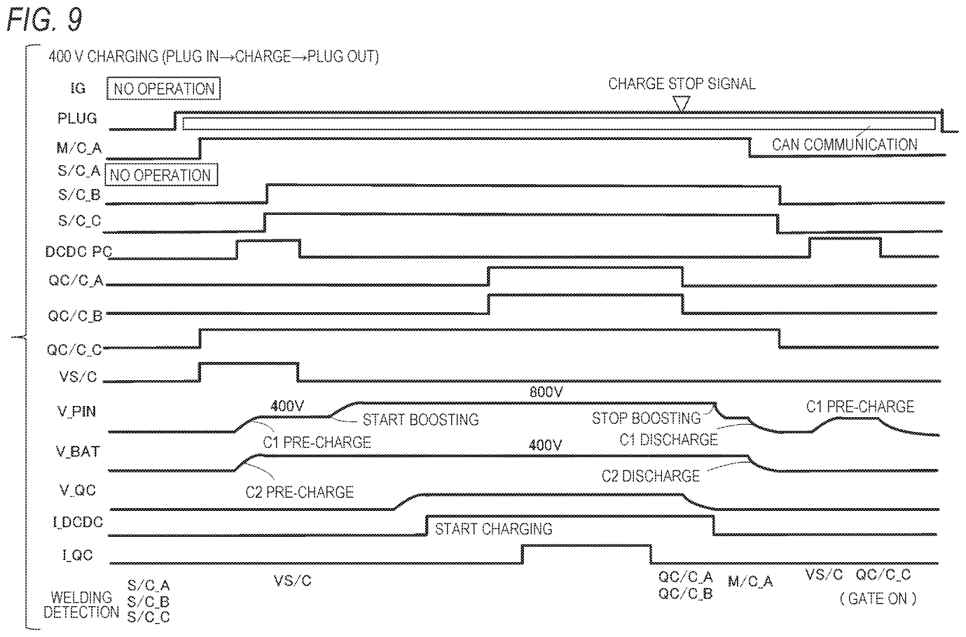

FIG. 6 illustrates a flow of a current during second-voltage charging (400 V charging) of the electric vehicle including the power storage system 1 according to the first embodiment, and FIG. 9 illustrates an operation sequence during the second-voltage charging (400 V charging) of the electric vehicle including the power storage system 1 according to the first embodiment.

When a charge plug is connected to the charge terminals 131P and 131N, the control unit 10 performs CAN communication with charging equipment to recognize a charge voltage. When the charge voltage is the second voltage (400 V), the control unit 10 first turns on the first contactor M/C_A, the seventh contactor VS/C, and the tenth contactor QC/C_C and checks the detected voltage values of the first voltage sensor V_PIN and the second voltage sensor V_BAT. When the detected voltage values of the first voltage sensor V_PIN and the second voltage sensor V_BAT increase, the control unit 10 determines that any one of the second to fourth contactors S/C_A, S/C_B, and S/C_C is welded and performs abnormality notification.

When the control unit 10 determines that the second to fourth contactors S/C_A, S/C_B, and S/C_C are not welded, the control unit 10 boosts the electric power of the second battery 7 to the second voltage (400 V) by the boost operation of the DC-DC converter 6 and pre-charges the first smoothing capacitor C1 and the second smoothing capacitor C2. When pre-charging of the first smoothing capacitor C1 and the second smoothing capacitor C2 is completed, the control unit 10 turns on the third contactor S/C_B and the fourth contactor S/C_C, connects the circuit in the first battery 2 in the second voltage state (400 V), then stops the boost operation of the DC-DC converter 6 and turns off the seventh contactor VS/C. After turning off the seventh contactor VS/C, the control unit 10 starts a boost operation performed by the three-phase motor 3 and the inverter 5 and checks the detected voltage value of the first voltage sensor V_PIN. When the detected voltage value of the first voltage sensor V_PIN does not increase, the control unit 10 determines that the seventh contactor VS/C is welded and performs abnormality notification. Here, if no abnormality occurs, the first battery 2 is in a state in which charging with the second voltage (400 V) can be started.

Thereafter, the control unit 10 turns on the eighth contactor QC/C_A and the ninth contactor QC/C_B to start charging the first battery 2 with the second voltage (400 V). At this time, the three-phase motor 3 and the inverter 5 connected to the DC power supply circuits 13P and 13N via the branch circuit 14 boost the second voltage (400 V) supplied from the charging equipment to the first voltage (800 V) to drive the auxiliary machine 4.

On the other hand, when the control unit 10 determines that a charge stop signal is received, the control unit 10 turns off the eighth contactor QC/C_A and the ninth contactor QC/C_B and checks a detected voltage value of the third voltage sensor V_QC. When the detected voltage value of the third voltage sensor V_QC does not decrease, the control unit 10 determines that the eighth contactor QC/C_A and the ninth contactor QC/C_B are welded and performs abnormality notification.

When the control unit 10 determines that the eighth contactor QC/C_A and the ninth contactor QC/C_B are not welded, the control unit 10 stops the boosting performed by the three-phase motor 3 and the inverter 5, then turns off the first contactor M/C_A and checks the detected voltage values of the first voltage sensor V_PIN and the second voltage sensor V_BAT. When the detected voltage values of the first voltage sensor V_PIN and the second voltage sensor V_BAT do not decrease due to discharging of the first and second smoothing capacitors C1 and C2, the control unit 10 determines that the first contactor M/C_A is welded, and performs abnormality notification.

When the control unit 10 determines that the first contactor M/C_A is not welded, the control unit 10 turns off the third contactor S/C_B, the fourth contactor S/C_C, and the tenth contactor QC/C_C after discharging of the first and second smoothing capacitors C1 and C2 is completed. Thereafter, the control unit 10 boosts the electric power of the second battery 7 to the second voltage (400 V) by the boost operation of the DC-DC converter 6, charges the first smoothing capacitor C1 again and checks the detected voltage value of the second voltage sensor V_BAT. When the detected voltage value of the second voltage sensor V_BAT increases, the control unit 10 determines that the seventh contactor VS/C is welded and performs abnormality notification.

When the control unit 10 determines that the seventh contactor VS/C is not welded, the control unit 10 turns on the gate of the inverter 5 and checks the detected voltage value of the first voltage sensor V_PIN. When the detected voltage value of the first voltage sensor V_PIN decreases, the control unit 10 determines that the tenth contactor QC/C_C is welded, and performs abnormality notification.

When the control unit 10 determines that the tenth contactor QC/C_C is not welded, the control unit 10 stops the boost operation of the DC-DC converter 6 and ends the operation sequence during second-voltage (400 V) charging.

Accordingly, regardless of whether the charge voltage is the first voltage (800 V) or the second voltage (400 V), it is possible to boost the electric power of the second battery 7 by the DC-DC converter 6 to pre-charge the first smoothing capacitor C1 and the second smoothing capacitor C2, thereby pre-charging the first smoothing capacitor C1 and the second smoothing capacitor C2 by using the DC-DC converter 6 which steps down the electric power of the first battery 2 and supplies the electric power to the second battery 7.

As described above, by changing the boost voltage when the first smoothing capacitor C1 and the second smoothing capacitor C2 are pre-charged between the case where the charge voltage is the first voltage (800 V) and the case where the charge voltage is the second voltage (400 V), it is possible to appropriately pre-charge the first smoothing capacitor C1 and the second smoothing capacitor C2 according to the charge voltage.

### Second Embodiment

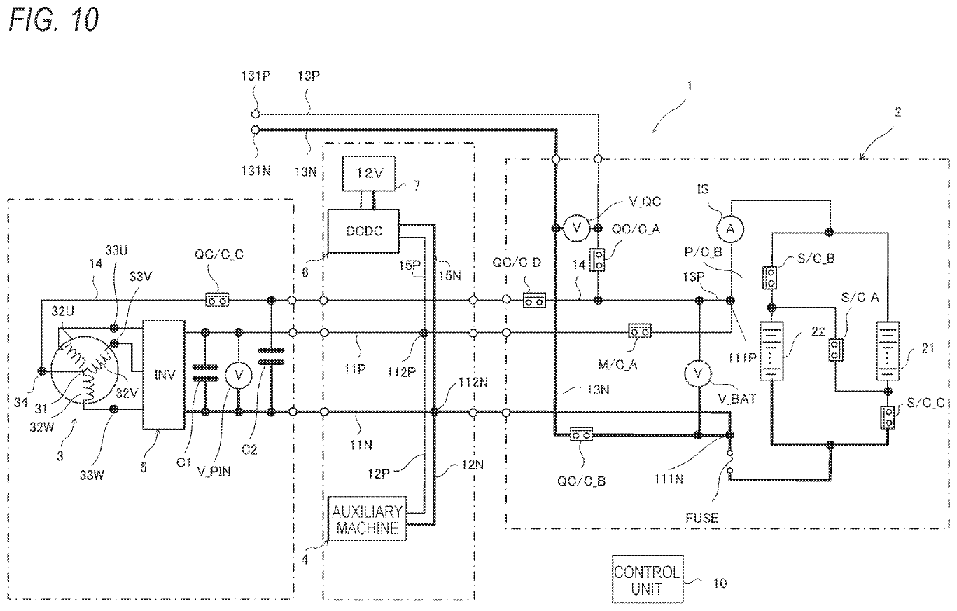

Next, a power storage system 1 according to a second embodiment will be described with reference to FIGS. 10 to 16. Here, the same reference numerals as in the first embodiment are used for the same configurations as in the first embodiment, and the description of the first embodiment may be incorporated.

In the power storage system 1 according to the first embodiment, the eighth contactor QC/C_A which is a main switch for charging is connected in series to the first contactor M/C_A which is the main switch of the battery 2. However, in the power storage system 1 according to the second embodiment, the eighth contactor QC/C_A is connected in parallel to the first contactor M/C_A as illustrated in FIG. 10.

In the power storage system 1 according to the second embodiment, the same effect as those of the power storage system 1 according to the first embodiment can be obtained. In addition, in the power storage system 1 according to the second embodiment, during the second-voltage (400 V) charging, the battery 2 charged with the second voltage (400 V) can be separated, by the first contactor M/C_A, from the first voltage (800 V) boosted by the three-phase motor 3 and the inverter 5, and thus no switch component corresponding to the seventh contactor VS/C in the first embodiment is required.

In the power storage system 1 according to the second embodiment, it is assumed that the eighth contactor QC/C_A, the ninth contactor QC/C_B, the second voltage sensor V_BAT, and the third voltage sensor V_QC are disposed in the battery 2 and the branch circuit 14 is drawn out from inside the battery 2. Therefore, an eleventh contactor QC/C_D is provided in the battery 2 at a position closer to the inverter 5 than a position in the vicinity of the branch of the branch circuit 14 in order to cut off connection with the outside of the battery when an abnormality occurs.

The second embodiment is similar to the first embodiment in that the second to fourth contactors S/C_A. S/C_B, and S/C_C are an example of the first switch unit and the tenth contactor QC/C_C is an example of the second switch unit. However, the second embodiment is different from the first embodiment in that the first contactor M/C_A is an example of the third switch unit.

In the power storage system 1 according to the second embodiment, the DC-DC converter 6 also boosts DC electric power from the second battery 7 to the first voltage (800 V) to pre-charge the first smoothing capacitor C1 and the second smoothing capacitor C2 when the electric vehicle starts traveling or 800 V charging is started. The DC-DC converter 6 boosts the DC electric power from the second battery 7 to a second voltage (400 V) to pre-charge the first smoothing capacitor C1 and the second smoothing capacitor C2 when 400 V charging is started.

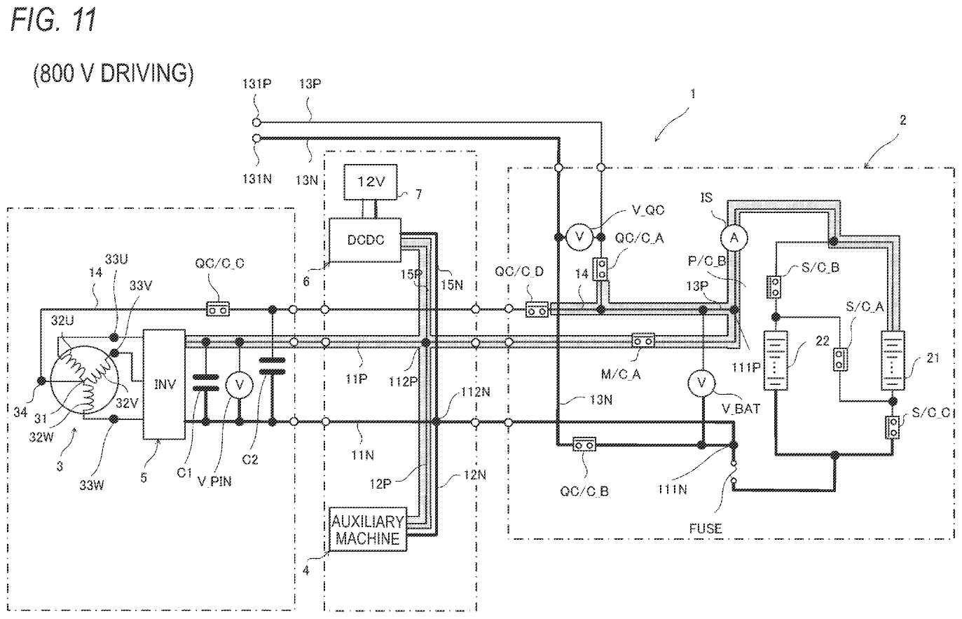

Next, an operation of the power storage system 1 according to the second embodiment will be described with reference to FIGS. 11 to 16.

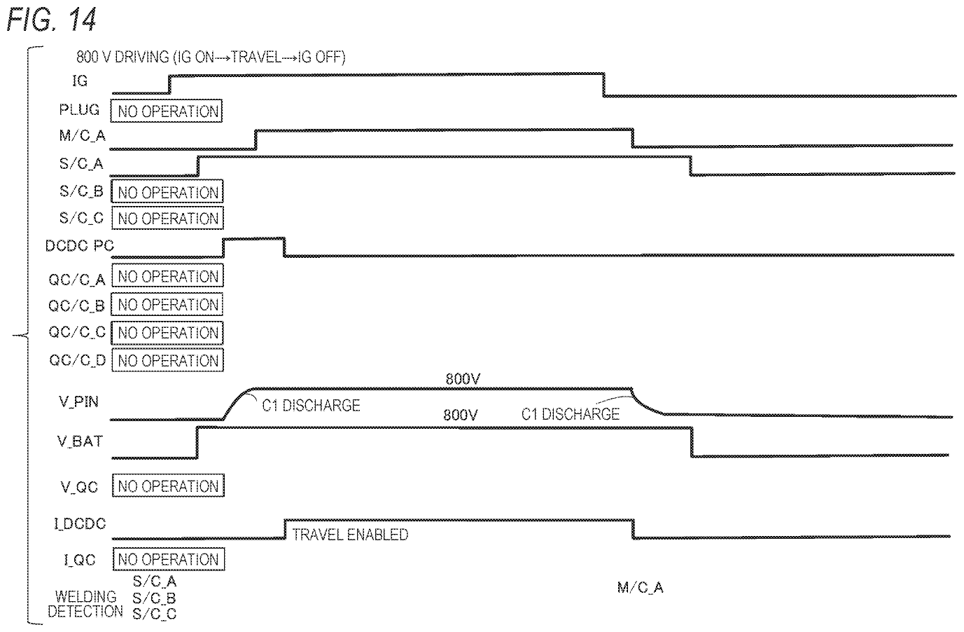

FIG. 11 illustrates a flow of a current during traveling (800 V driving) of the electric vehicle including the power storage system 1 according to the second embodiment, and FIG. 14 illustrates an operation sequence during the traveling (800 V driving) of the electric vehicle including the power storage system 1 according to the second embodiment.

When the ignition switch IG of the electric vehicle is turned on, the control unit 10 first checks the detected voltage value of the second voltage sensor V_BAT. When the detected voltage value of the second voltage sensor V_BAT increases, the control unit 10 determines that any one of the second to fourth contactors S/C_A, S/C_B, and S/C_C is welded, and performs abnormality notification.

When the control unit 10 determines that the second to fourth contactors S/C_A, S/C_B, and S/C_C are not welded, the control unit 10 turns on the second contactor S/C_A to connect the circuit in the first battery 2 to the first voltage state (800 V startup), then boosts the electric power of the second battery 7 to the first voltage (800 V) by the boost operation of the DC-DC converter 6 and pre-charges the first smoothing capacitor C1. When pre-charging of the first smoothing capacitor C1 is completed, the control unit 10 turns on the first contactor M/C_A and then stops the boost operation of the DC-DC converter 6. Accordingly, travel of the electric vehicle is enabled. At this time, the auxiliary machine 4 is connected to the electric power supply circuits 11P and 11N via the auxiliary machine drive circuits 12P and 12N and is driven by the first voltage (800 V) supplied from the battery 2.

On the other hand, when the ignition switch IG is turned off, the control unit 10 first turns off the first contactor M/C_A and checks the detected voltage value of the first voltage sensor V_PIN. When the detected voltage value of the first voltage sensor V_PIN does not decrease due to discharging of the first smoothing capacitor C1, the control unit 10 determines that the first contactor M/C_A is welded and performs abnormality notification.

When the control unit 10 determines that the first contactor M/C_A is not welded, the control unit 10 turns off the second contactor S/C_A after discharging of the first smoothing capacitor C1 is completed, and ends the operation sequence during traveling.

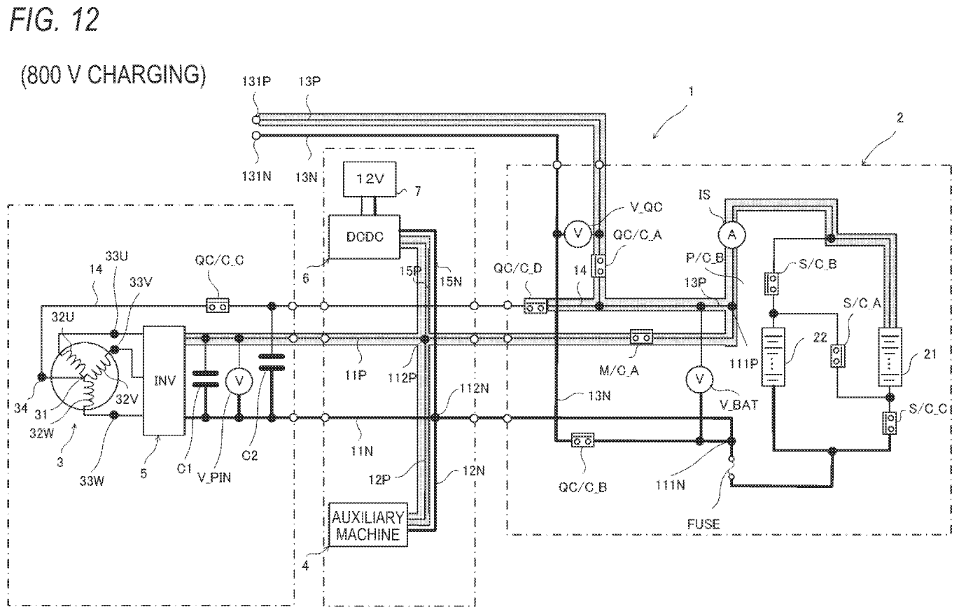

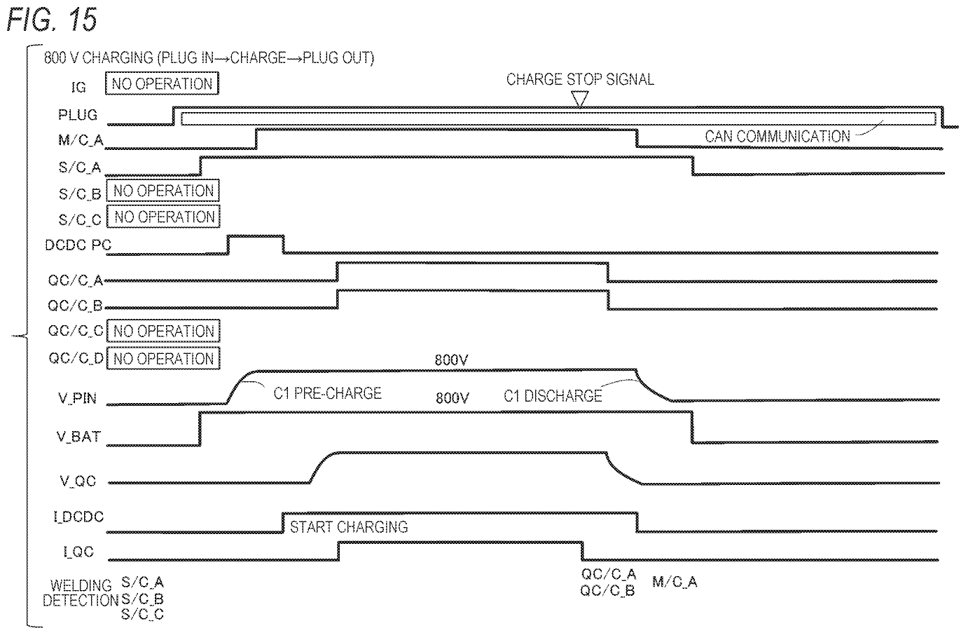

FIG. 12 illustrates a flow of a current during first-voltage charging (800 V charging) of the electric vehicle including the power storage system 1 according to the second embodiment, and FIG. 15 illustrates an operation sequence during the first-voltage charging (800 V charging) of the electric vehicle including the power storage system 1 according to the second embodiment.

When a charge plug is connected to the charge terminals 131P and 131N, the control unit 10 performs CAN communication with the charging equipment to recognize a charge voltage, and checks the detected voltage value of the second voltage sensor V_BAT. When the detected voltage value of the second voltage sensor V_BAT increases, the control unit 10 determines that any one of the second to fourth contactors S/C_A, S/C_B, and S/C_C is welded, and performs abnormality notification.

When the control unit 10 determines that the second to fourth contactors S/C_A, S/C_B, and S/C_C are not welded and the charge voltage is the first voltage (800 V), the control unit 10 turns on the second contactor S/C_A to connect the circuit in the first battery 2 to the first voltage state (800 V startup), then boosts the electric power of the second battery 7 to the first voltage (800 V) by the boost operation of the DC-DC converter 6 and pre-charges the first smoothing capacitor C1. When pre-charging of the first smoothing capacitor C1 is completed, the control unit 10 turns on the first contactor M/C_A and then stops the boost operation of the DC-DC converter 6. Accordingly, the first battery 2 is in a state in which charging with the first voltage (800 V) can be started.

Thereafter, the control unit 10 turns on the eighth contactor QC/C_A and the ninth contactor QC/C_B to start charging the first battery 2 with the first voltage (800 V). At this time, the auxiliary machine 4 is connected to the DC power supply circuits 13P and 13N via the auxiliary machine drive circuits 12P and 12N and the first contactor M/C_A and is driven by the first voltage (800 V) supplied from the charging equipment.

On the other hand, when the control unit 10 determines that a charge stop signal is received, the control unit 10 turns off the eighth contactor QC/C_A and the ninth contactor QC/C_B and checks a detected voltage value of the third voltage sensor V_QC. When the detected voltage value of the third voltage sensor V_QC does not decrease, the control unit 10 determines that the eighth contactor QC/C_A and the ninth contactor QC/C_B are welded and performs abnormality notification.

When the control unit 10 determines that the eighth contactor QC/C_A and the ninth contactor QC/C_B are not welded, the control unit 10 turns off the first contactor M/C_A and checks the detected voltage value of the first voltage sensor V_PIN. When the detected voltage value of the first voltage sensor V_PIN does not decrease due to discharging of the first smoothing capacitor C1, the control unit 10 determines that the first contactor M/C_A is welded and performs abnormality notification.

When the control unit 10 determines that the first contactor M/C_A is not welded, the control unit 10 turns off the second contactor S/C_A after discharging of the first smoothing capacitor C1 is completed, and ends the operation sequence during the first-voltage (800 V) charging.

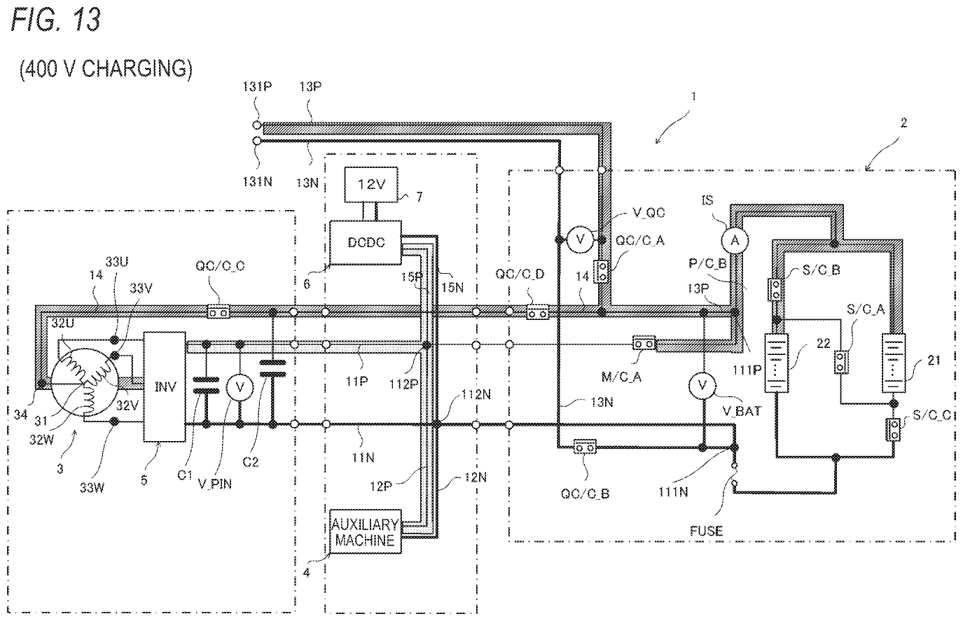

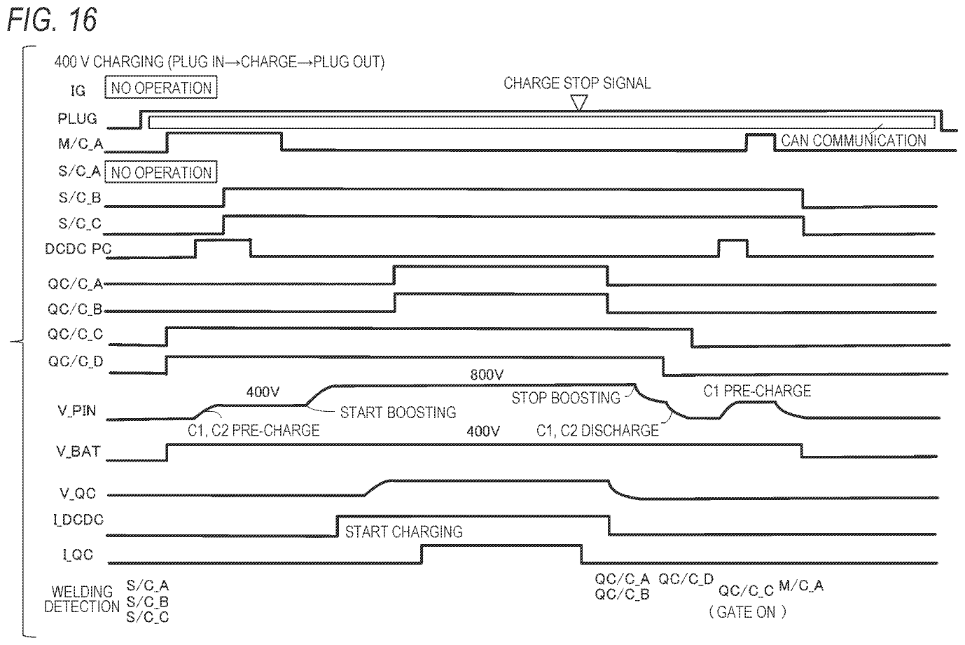

FIG. 13 illustrates a flow of a current during second-voltage charging (400 V charging) of the electric vehicle including the power storage system 1 according to the second embodiment, and FIG. 16 illustrates an operation sequence during the second-voltage charging (400 V charging) of the electric vehicle including the power storage system 1 according to the second embodiment.

When a charge plug is connected to the charge terminals 131P and 131N, the control unit 10 performs CAN communication with the charging equipment to recognize a charge voltage, and checks the detected voltage value of the second voltage sensor V_BAT. When the detected voltage value of the second voltage sensor V_BAT increases, the control unit 10 determines that any one of the second to fourth contactors S/C_A, S/C_B, and S/C_C is welded, and performs abnormality notification.

When the control unit 10 determines that the second to fourth contactors S/C_A, S/C_B, and S/C_C are not welded and the charge voltage is the second voltage (400 V), the control unit 10 turns on the first contactor M/C_A, the tenth contactor QC/C_C, and the eleventh contactor QC/C_D, then boosts the electric power of the second battery 7 to the second voltage (400 V) by the boost operation of the DC-DC converter 6 and pre-charges the first smoothing capacitor C1 and the second smoothing capacitor C2. When pre-charging of the first smoothing capacitor C1 and the second smoothing capacitor C2 is completed, the control unit 10 turns on the third contactor S/C_B and the fourth contactor S/C_C, connects the circuit in the first battery 2 in the second voltage state (400 V) and then stops the boost operation of the DC-DC converter 6. In addition, the control unit 10 turns off the first contactor M/C_A and then starts the boost operation performed by the three-phase motor 3 and the inverter 5. Accordingly, the first battery 2 is in a state in which charging with the second voltage (400 V) can be started.

Thereafter, the control unit 10 turns on the eighth contactor QC/C_A and the ninth contactor QC/C_B to start charging the first battery 2 with the second voltage (400 V). At this time, the three-phase motor 3 and the inverter 5 connected to the DC power supply circuits 13P and 13N via the branch circuit 14 boost the second voltage (400 V) supplied from the charging equipment to the first voltage (800 V) to drive the auxiliary machine 4.

On the other hand, when the control unit 10 determines that a charge stop signal is received, the control unit 10 turns off the eighth contactor QC/C_A and the ninth contactor QC/C_B and checks a detected voltage value of the third voltage sensor V_QC. When the detected voltage value of the third voltage sensor V_QC does not decrease, the control unit 10 determines that the eighth contactor QC/C_A and the ninth contactor QC/C_B are welded and performs abnormality notification.

When the control unit 10 determines that the eighth contactor QC/C_A and the ninth contactor QC/C_B are not welded, the control unit 10 stops the boosting performed by the three-phase motor 3 and the inverter 5, then turns off the eleventh contactor QC/C_D and checks the detected voltage value of the first voltage sensor V_PIN. When the detected voltage value of the first voltage sensor V_PIN does not decrease due to discharging of the first and second smoothing capacitors C1 and C2, the control unit 10 determines that the eleventh contactor QC/C_D is welded, and performs abnormality notification.

When the control unit 10 determines that the eleventh contactor QC/C_D is not welded, the control unit 10 turns off the tenth contactor QC/C_C after discharging of the first and second smoothing capacitors C1 and C2 is completed, then boosts the electric power of the second battery 7 to the second voltage (400 V) by the boost operation of the DC-DC converter 6 and pre-charges the first smoothing capacitor C1 again. When pre-charging of the first smoothing capacitor C1 is completed, the control unit 10 stops the boost operation of the DC-DC converter 6, then turns on the first contactor M/C_A, turns on the gate of the inverter 5 and checks the detected voltage value of the first voltage sensor V_PIN. When the detected voltage value of the first voltage sensor V_PIN changes in response to the turn-on of the gate of the inverter 5, the control unit 10 determines that the tenth contactor QC/C_C is welded, and performs abnormality notification.

When the control unit 10 determines that the tenth contactor QC/C_C is not welded, the control unit 10 turns off the first contactor M/C_A and checks the detected voltage value of the first voltage sensor V_PIN. When the detected voltage value of the first voltage sensor V_PIN does not decrease due to discharging of the first smoothing capacitor C1, the control unit 10 determines that the first contactor M/C_A is welded and performs abnormality notification.

When the control unit 10 determines that the first contactor M/C_A is not welded, the control unit 10 turns off the third contactor S/C_B and the fourth contactor S/C_C and ends the operation sequence during the second-voltage (400 V) charging.

Although various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, respective constituent elements in the above-described embodiments may be freely combined without departing from the gist of the invention.

For example, in the above embodiment, the control unit 10 performs CAN communication with the charging equipment, but the communication method is not limited to CAN communication, and any communication method can be adopted.

In the present specification, at least the following matters are described. Corresponding constituent elements and the like in the embodiment described above are shown in parentheses, but the present invention is not limited thereto.

(1) A power storage system including.
a first battery (first battery 2) including a first power storage unit (first power storage unit 21), a second power storage unit (second power storage unit 22), and a first switch unit (second contactor S/C_A, third contactor S/C_B, and fourth contactor S/C_C), the first switch unit being configured to switch between a first voltage state in which the first power storage unit and the second power storage unit are connected in series and chargeable at a first voltage (800 V), and a second voltage state in which the first power storage unit and the second power storage unit are connected in parallel and chargeable at a second voltage (400 V);
a three-phase motor (three-phase motor 3) including coils (coils 32U, 32V, and 32W) of three phases connected at a neutral point (neutral point 31), the three-phase motor being configured to be driven by electric power supplied from the first battery;
an inverter (inverter 5) connected on an electric power transmission path (electric power supply circuits 11P and 11N) between the first battery and the three-phase motor;
a DC power supply circuit (DC power supply circuits 13P and 13N) connected to a connection portion (connection portions 111P and 111N) located on an electric power transmission path between the inverter and the first battery;
a branch circuit (branch circuit 14) branched from the DC power supply circuit on a positive electrode side and connected to the neutral point;
a capacitor (first smoothing capacitor C1 and second smoothing capacitor C2) including one end and an other end, the one end being connected to a negative-electrode-side electric power supply circuit (electric power supply circuit 11N on negative electrode side) which connects the inverter and the first battery, and the other end being connected to the branch circuit or a positive-electrode-side electric power supply circuit (electric power supply circuit 11P on positive electrode side) which connects the inverter and the first battery;
a pre-charge circuit (converter circuits 15P and 15N) located on the electric power transmission path between the inverter and the first battery and connected between the inverter and the connection portion of the DC power supply circuit;
a converter (DC-DC converter 6) connected to the pre-charge circuit; and
a second battery (second battery 7) connected to the converter and having a voltage lower than the first voltage and the second voltage.

According to (1), it is possible to appropriately perform charging according to a voltage state of charging equipment by switching, by the first switch unit, a mode of connection between the first power storage unit and the second power storage unit both in a system in which the external charging equipment performs charging at the first voltage or a system in which the external charging equipment performs charging at the second voltage. That is, charging can be performed without passing through any voltage converter during charging, efficiency deterioration due to the voltage converter can be avoided, and need for the voltage converter for charging can be eliminated.

In addition, since the positive-electrode-side DC power supply circuit connected to the connection portion located on the electric power transmission path between the inverter and the battery includes the branch circuit connected to the neutral point of the three-phase motor, voltage conversion can be performed using the three-phase motor and the inverter. Accordingly, even when the voltage state of the charging equipment is different from an operating voltage of an auxiliary machine or the like, need for a dedicated voltage converter can be eliminated, and thus a manufacturing cost can be reduced.

Further, the capacitor can be pre-charged with electric power of the second battery.

(2) The power storage system according to (1), in which
the converter is a bidirectional converter.

According to (2), the capacitor can be pre-charged with the electric power of the second battery, and the second battery can be charged with electric power of the first battery.

(3) The power storage system according to (1), in which
the capacitor includes:
a first capacitor (first smoothing capacitor C1) including one end and an other end, the one end being connected to the negative-electrode-side electric power supply circuit, and the other end being connected to the positive-electrode-side electric power supply circuit; and
a second capacitor (second smoothing capacitor C2) including one end and an other end, the one end being connected to the negative-electrode-side electric power supply circuit, and the other end being connected to the branch circuit.

According to (3), an inrush current can be inhibited both in the first voltage state and in the second voltage state. In addition, both in the first voltage state and in the second voltage state, the capacitor can be pre-charged by the converter with the electric power of the second battery.

(4) The power storage system according to (1), further including:
a control unit (control unit 10) configured to control the first switch unit, the inverter, and the converter, in which
the control unit is configured to switch the first switch unit and change a boost voltage of the converter according to a charge voltage of the DC power supply circuit.

According to (4), a voltage can be adjusted to an appropriate voltage by the converter according to the charge voltage of the DC power supply circuit.

(5) The power storage system according to (4), in which:
when the charge voltage of the DC power supply circuit is the first voltage, the control unit is configured to set the boost voltage of the converter to the first voltage, pre-charge the capacitor by the pre-charge circuit, and then control the first switch unit to switch the first battery to the first voltage state; and
when the charge voltage of the DC power supply circuit is the second voltage, the control unit is configured to set the boost voltage of the converter to the second voltage, pre-charge the capacitor by the pre-charge circuit, and then control the first switch unit to switch the first battery to the second voltage state.

According to (5), the voltage can be adjusted to an appropriate voltage by the converter according to the charge voltage of the DC power supply circuit, and the capacitor can be pre-charged.

(6) The power storage system according to (1), in which
the branch circuit is connected to the neutral point via a second switch unit (tenth contactor QC/C_C).

According to (6), when the three-phase motor does not perform voltage conversion, that is, when the coils of the three-phase motor are not used as transformers, connection to the neutral point can be cut off.

(7) The power storage system according to any one of (1) to (6), further including:
an auxiliary machine (auxiliary machine 4) configured to be driven by DC electric power from the second battery and an external power supply; and
an auxiliary machine drive circuit (auxiliary machine drive circuits 12P and 12N) connected on an electric power transmission path between the inverter and the connection portion and configured to supply electric power to the auxiliary machine, in which
the auxiliary machine is operated at the first voltage.

According to (7), need for voltage conversion is eliminated during traveling and during charging at the first voltage.

(8) The power storage system according to (7), further including:
a control unit (control unit 10) configured to control the first switch unit, the inverter, and the converter, in which
when the charge voltage of the DC power supply circuit is the second voltage, the control unit causes the inverter to boost a voltage supplied from the branch circuit to the three-phase motor to the first voltage after pre-charging.

According to (8), since voltage conversion can be performed using the three-phase motor and the inverter, need for an auxiliary machine voltage converter can be eliminated.

(9) The power storage system according to (7), in which
the auxiliary machine is connected to the first battery via a third switch unit (seventh contactor VS/C in first embodiment and first contactor M/C_A in second embodiment).

According to (9), when voltage conversion is performed by the three-phase motor, that is, when the coils of the three-phase motor are used as transformers, the third switch unit can separate a portion having the first voltage from a portion having the second voltage.

What is claimed is:

1. A power storage system comprising:
a first battery including a first power storage unit, a second power storage unit, and a first switch unit, the first switch unit being configured to switch between a first voltage state in which the first power storage unit and the second power storage unit are connected in series and chargeable at a first voltage, and a second voltage state in which the first power storage unit and the second power storage unit are connected in parallel and chargeable at a second voltage;
a three-phase motor including coils of three phases connected at a neutral point, the three-phase motor being configured to be driven by electric power supplied from the first battery;
an inverter connected on an electric power transmission path between the first battery and the three-phase motor;
a DC power supply circuit connected to a connection portion located on an electric power transmission path between the inverter and the first battery;
a branch circuit branched from the DC power supply circuit on a positive electrode side and connected to the neutral point;
a capacitor including one end and an other end, the one end being connected to a negative-electrode-side electric power supply circuit which connects the inverter and the first battery, and the other end being connected to the branch circuit or a positive-electrode-side electric power supply circuit which connects the inverter and the first battery;
a pre-charge circuit located on the electric power transmission path between the inverter and the first battery and connected between the inverter and the connection portion of the DC power supply circuit;
a converter connected to the pre-charge circuit; and
a second battery connected to the converter and having a voltage lower than the first voltage and the second voltage.

2. The power storage system according to claim 1, wherein
the converter is a bidirectional converter.

3. The power storage system according to claim 1,
wherein the capacitor includes:
a first capacitor including one end and an other end, the one end being connected to the negative-electrode-side electric power supply circuit, and the other end being connected to the positive-electrode-side electric power supply circuit; and
a second capacitor including one end and an other end, the one end being connected to the negative-electrode-side electric power supply circuit, and the other end being connected to the branch circuit.

4. The power storage system according to claim 1, further comprising:
a control unit configured to control the first switch unit, the inverter, and the converter, wherein
the control unit is configured to switch the first switch unit and change a boost voltage of the converter according to a charge voltage of the DC power supply circuit.

5. The power storage system according to claim 4, wherein:
when the charge voltage of the DC power supply circuit is the first voltage, the control unit is configured to set the boost voltage of the converter to the first voltage, pre-charge the capacitor by the pre-charge circuit, and then control the first switch unit to switch the first battery to the first voltage state; and
when the charge voltage of the DC power supply circuit is the second voltage, the control unit is configured to set the boost voltage of the converter to the second voltage, pre-charge the capacitor by the pre-charge circuit, and then control the first switch unit to switch the first battery to the second voltage state.

6. The power storage system according to claim 1, wherein
the branch circuit is connected to the neutral point via a second switch unit.

7. The power storage system according to claim 1, further comprising:
an auxiliary machine configured to be driven by DC electric power from the second battery and an external power supply; and
an auxiliary machine drive circuit connected on an electric power transmission path between the inverter and the connection portion and configured to supply electric power to the auxiliary machine, wherein
the auxiliary machine is operated at the first voltage.

8. The power storage system according to claim 7, further comprising:
a control unit configured to control the first switch unit, the inverter, and the converter, wherein
when the charge voltage of the DC power supply circuit is the second voltage, the control unit causes the inverter to boost a voltage supplied from the branch circuit to the three-phase motor to the first voltage after pre-charging.

9. The power storage system according to claim 7, wherein
the auxiliary machine is connected to the first battery via a third switch unit.
